(19) United States
(12) Patent Application Publication
(10) Pub. No.: US 2008/0024427 A1
(43) Pub. Date: Jan. 31, 2008

(54) Electronic ink display panel

(75) Inventors: Chia-Hao Kuo, Hsinchu (TW); Chuan-Feng Liu, Hsinchu (TW); Yu-Chen Hsu, Hsinchu (TW)

Correspondence Address: SHEEHAN PHINNEY BASS & GREEN, PA;c/o PETER NIEVES, 1000 ELM STREET, MANCHESTER, NH, 03105-3701, US

(73) Assignee: PRIME VIEW INTERNATIONAL CO., LTD.

(21) Appl. No.: 11/493,341

(22) Filed: Jul. 26, 2006

(51) Int. Cl. G09G 3/34

(52) U.S. Cl. 345/107

(57) ABSTRACT

An E-ink display panel including a substrate, display pixels, dummy pixels, a display medium and a common electrode is provided. The display pixels are disposed on the substrate and arranged in a matrix for defining a display region. The dummy pixels are disposed on the substrate and adjacent to the display pixels. The display medium is disposed over the display pixels and the dummy pixels. The common electrode is disposed on the display medium. The display medium above the display pixels is driven by the bias voltage between the display pixel and the common electrode such that an image is displayed by the display medium, and display state of the display medium above the dummy pixels is not affected by the bias voltage between the dummy pixel and the common electrode. The dummy pixels are adapted for preventing the display pixels from being damaged directly due to an ESD.

### BACKGROUND OF THE INVENTION

1. Field of the Invention

The present invention generally relates to an electronic ink (E-ink) display panel, in particular, to an E-ink display panel having an electrostatic discharge (ESD) protection design.

2. Description of Related Art

An Electronic Paper Display (EPD) is a display that possesses a paper-like high contrast appearance, ultra-low power consumption, and a thin, flexible and light form. It gives the viewer the experience of reading from paper, while having the power of updatable information. EPDs are a technology enabled by electronic ink (E-ink) that carries a charge enabling it to be updated through electronics. E-ink is ideally suited for EPDs as it is a reflective technology which requires no front or backlight, is viewable under a wide range of lighting conditions, including direct sunlight, and requires no power to maintain an image.

Please refer to FIG. 1, one type of E-ink technique is described. the principle This type of E-ink material constructed by millions of tiny microcapsules 100, about the diameter of a human hair. In one incarnation, each microcapsule 100 contains positively charged white particles 120a and negatively charged black particles 120b suspended in a clear fluid 110. When an electric field is applied, the white particles 120a are attracted to move to the top of the microcapsule 100. This makes the spot surface appear white. At the same time, an opposite-direction electric field pulls the black particles 120b to the bottom of the microcapsule 100. By using inverse bias, the black particles 120b would appear at the top of the microcapsule 100-and makes the spot surface appear dark. While this is just the most successful e-ink technique but not the only type. The charge type arrangement with color tone can be switched to fit in different need.

FIG. 2 is a schematic, perspective exploded view showing a conventional active-matrix E-ink display. The active-matrix E-ink display mainly comprises a thin film transistor (TFT) array substrate 210, an ink layer 220 and a common electrode 230, and the ink layer 220 is sandwiched between the TFT array substrate 210 and the common electrode 230. The TFT array substrate 210 comprises a plurality of scan lines 212 and a plurality of data lines 214 for defining a plurality of pixel units arranged in a matrix. Each pixel unit comprises a TFT 216a and a pixel electrode 216b electrically connected thereto, and the TFT 216a is driven by the corresponding scan line 212 and data line 214. The ink layer 220 comprises a plurality of microcapsules 222 serving as the display medium, and the microcapsules 222 can be disposed on a transparent, plastic substrate (not shown). The white particles and black particles within the microcapsules 222 of each pixel are driven by the bias voltage between the pixel electrode 216b and the common electrode 230, to change the gray level of each pixel.

During the fabrication process of E-ink display, electrostatic charges would be accumulated on the fabrication equipments, operators, display panels and so on. Therefore, when E-ink display panels are in contact with the fabrication equipments, operators or other electrically charged objects during the fabrication process, the so-called “electrostatic discharge” (ESD) phenomenon would be occurred. Since the components inside the E-ink display have very small dimensions, the damaging effect caused by the ESD on the circuits inside the E-ink display is permanent.

For the existing E-ink display, an ESD often leads to the production of dot defects or line defects on the display panel, especially the pixels arranged in the outer matrix rows and columns. And this would make the fabrication yield rate of the E-ink display panel lower and the expected lifetime thereof decreased. Therefore, how to prevent the pixels disposed within a main display region of the E-ink display from being damaged by the ESD current is an important issue in this technology.

### SUMMARY OF THE INVENTION

Accordingly, the present invention is directed to an E-ink display panel having an ESD protection design.

The present invention is directed to an E-ink display panel comprising a substrate, a plurality of display pixels, a plurality of dummy pixels, a display medium and a common electrode. The display pixels are disposed on the substrate and arranged in a matrix for defining a display region. The dummy pixels are disposed on the substrate and adjacent to the display pixels. The display medium is disposed over the display pixels and the dummy pixels. The common electrode is disposed on the display medium. Wherein, the display medium above the display pixels is driven by the bias voltage between the display pixel and the common electrode such that an image is displayed by the display medium, and display state of the display medium above the dummy pixels is controlled by the bias voltage between the dummy pixel and the common electrode.

According to an embodiment of the present invention, each display pixel comprises a display thin film transistor disposed on the substrate and a display pixel electrode which is electrically connected to the display thin film transistor.

According to an embodiment of the present invention, each dummy pixel comprises a dummy thin film transistor disposed on the substrate and a dummy pixel electrode which is electrically connected to the dummy thin film transistor.

According to an embodiment of the present invention, all the dummy pixel electrodes of the dummy pixels are electrically connected to one another.

According to an embodiment of the present invention, a portion of the dummy pixel electrodes of the dummy pixels are electrically connected to one another.

According to an embodiment of the present invention, the dummy pixel electrodes of the dummy pixels are electrically isolated from one another.

According to an embodiment of the present invention, the substrate comprises a rigid substrate or a flexible substrate.

According to an embodiment of the present invention, the display medium comprises a plurality of capsules. Each capsule comprises a fluid, a plurality of positively charged pigments and a plurality of negatively charged pigments. The positively charged pigments and the negatively charged pigments are suspended in the fluid.

According to an embodiment of the present invention, the positively charged pigments are white pigments and the negatively charged pigments are black pigments.

According to an embodiment of the present invention, the layout of the display pixels is identical with that of the dummy pixels.

According to an embodiment of the present invention, the layout of the display pixels is different from that of the dummy pixels.

According to an embodiment of the present invention, the E-ink display panel further comprises a display driver disposed on the substrate for driving the display pixels and the dummy pixels.

According to an embodiment of the present invention, the dummy pixels are disposed on at least one side of the display region.

According to an embodiment of the present invention, the dummy pixels are disposed on two parallel sides of the display region.

According to an embodiment of the present invention, the dummy pixels are disposed on two adjacent sides of the display region.

According to an embodiment of the present invention, the display region is surrounded by the dummy pixels.

In summary, the E-ink display panel of the present invention utilizes the dummy pixels adjacent to the display pixels, to prevent the display pixels from being damaged directly due to an ESD. The dummy pixels can be disposed on at least one side of the display region or surround the display region in accordance with practical demands. The arrangement of the dummy pixels is helpful for improving the display quality and the life time of the E-ink display panel. Besides, all the dummy pixel electrodes of the dummy pixels surrounding the display pixels can be electrically connected to one another, and thus they may share the ESD current at the same time, to further prevent the display pixels from being damaged.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating the principle of E-ink display.

FIG. 2 is a schematic, perspective exploded view showing a conventional active-matrix E-ink display.

FIG. 3A is a schematic, perspective exploded view showing an E-ink display panel according to an embodiment of the present invention.

FIG. 3B is a schematic vertical view showing a substrate shown in FIG. 3A.

FIGS. 4A and 4B are schematic vertical views showing the dummy pixels with different layout.

FIGS. 5A to 5D are schematic, perspective exploded view showing E-ink display panels having different arrangement of the dummy pixels according to other embodiments of the present invention.

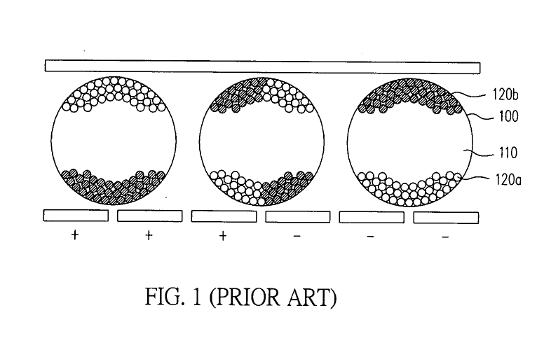

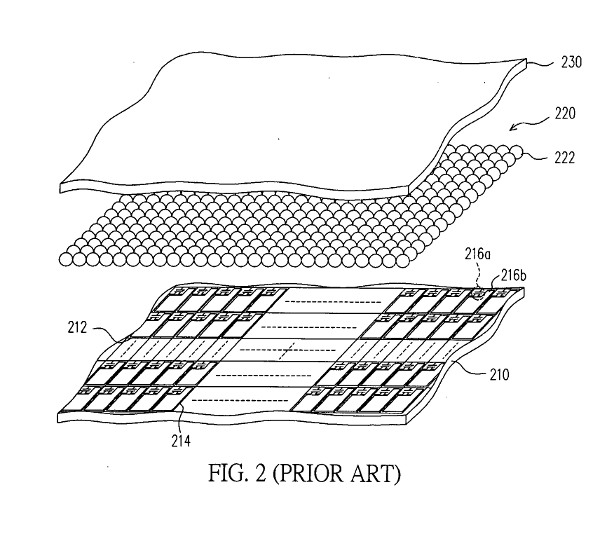

### DESCRIPTION OF THE EMBODIMENTS

Reference will now be made in detail to the preferred embodiments of the invention, examples of which are illustrated in the accompanying drawings. Wherever possible, the same reference numbers are used in the drawings and the description to refer to the same or like parts.

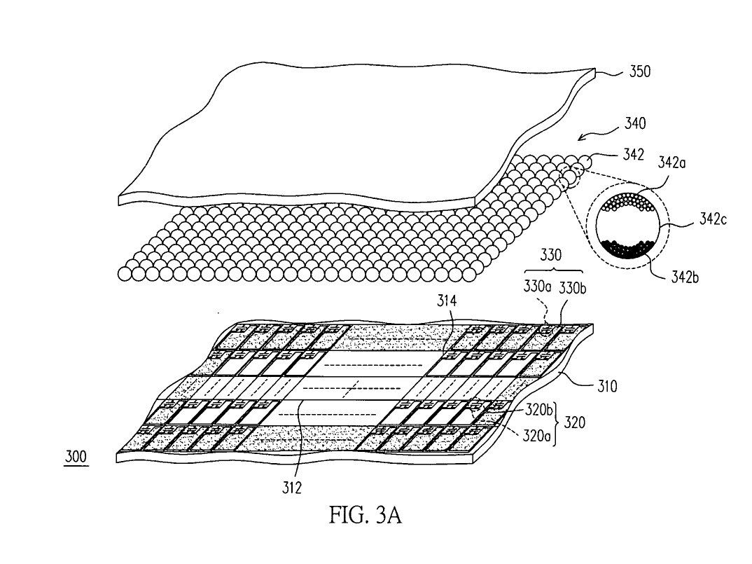

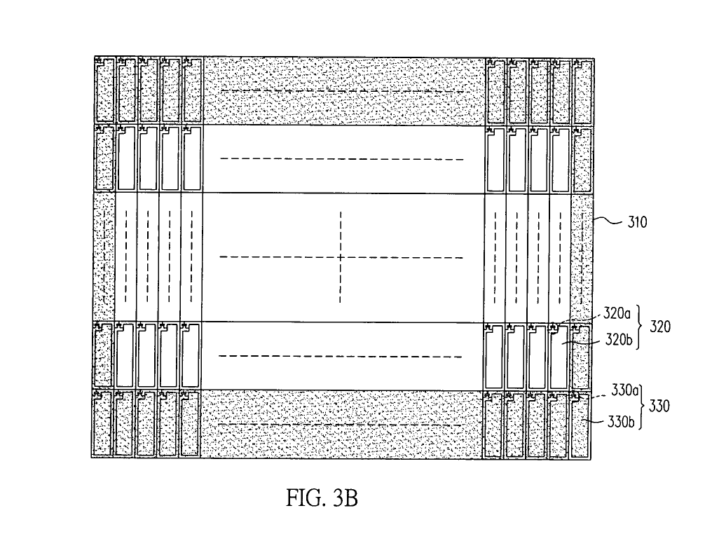

Please refer to FIGS. 3A and 3B, the E-ink display panel 300 mainly comprises a substrate 310, a plurality of display pixels 320, a plurality of dummy pixels 330, a display medium 340 and a common electrode 350; the dummy pixels 330 are the dotted region shown in FIG. 3A. The present invention utilizes the dummy pixels 330 surrounding the display pixels 320 to prevent the damages inflicted upon the display pixels 320 directly due to possible ESD. Therefore, the display quality of the E-ink display panel 300 is improved and the manufacturing yield of the E-ink display panel 300 could be increased.

The substrate 310 can be a rigid substrate, like a glass substrate, or a flexible substrate in accordance with practical demands. A plurality of scan lines 312 and data lines 314 are formed on the substrate 310 by a semiconductor process to define a plurality of pixels arranged in a matrix. These pixels comprise the display pixels 320 and the dummy pixels 330 driven by the corresponding scan lines 312 and data lines 314, and the dummy pixels 330 are adjacent to the display pixels 320. In this embodiment, the display pixels 320 are surrounded by the dummy pixels 330. Therefore, these dummy pixels 330 serve as buffers against any damages when ESD occurs, and the display pixels 320 would not be damaged directly. Therefore, the yield rate and display quality of the display panel are improved. More specifically, each display pixel 320 comprises a display thin film transistor 320a disposed on the substrate 310 and a display pixel electrode 320b electrically connected to the display thin film transistor 320a, and each dummy pixel 330 comprises a dummy thin film transistor 330a disposed on the substrate 310 and a dummy pixel electrode 330b electrically connected to the dummy thin film transistor 330a. The E-ink display panel 300 further comprises a display driver (not shown) disposed on the substrate 310 for driving the display pixels 320 and the dummy pixels 330.

The E-ink display medium 340 is disposed over the display pixels 320 and the dummy pixels 330, and the display medium 340 comprises a plurality of capsules 342. Each capsule 342 contains a plurality of positively charged pigments 342a and negatively charged pigments 342b suspended in a clear fluid 342c. The display mechanism of the capsules 342 has been discussed before, and it is not repeated herein. In one embodiment of the present invention, the positively charged pigments 342a can be white pigments, and the negatively charged pigments 342b are black pigments.

The common electrode 350 is disposed on the display medium 340, and it can be an indium tin oxide (ITO) layer or other transparent conductive film formed on a transparent substrate. The display medium 340 disposed above the display pixels 320 is driven by the bias voltage between the display pixel electrode 320b of the display pixel 320 and the common electrode 350, such that an image is displayed through reflecting incident light by the display medium 340. However, the dummy pixels 330 serve as the ESD protection device; therefore, the display state of the display medium 340 above the dummy pixels 330 is controlled by the bias voltage between the dummy pixel electrode 330b of the dummy pixel 330 and the common electrode 350.

In this embodiment, the layout of the display pixels 320 could be is identical with that of the dummy pixels 330. In another embodiment, the layout of the display pixels 320 can be different with that of the dummy pixels 330, and the layout of the display pixels 320 and the dummy pixels 330 is not restricted in the present invention.

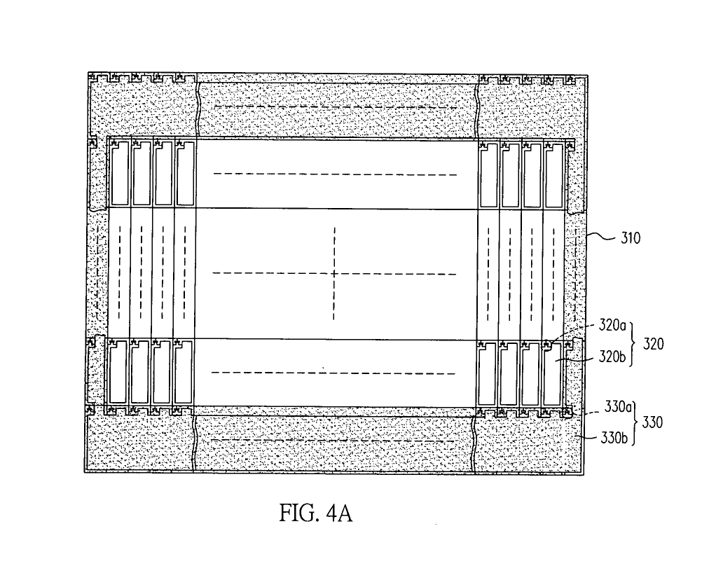

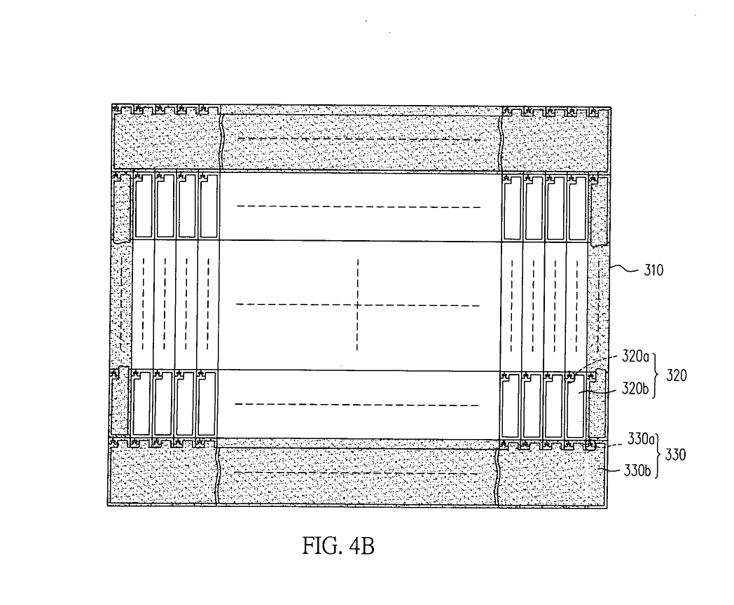

As shown in FIGS. 3A and 3B, all the dummy pixel electrodes 330b of the dummy pixels 330 are electrically isolated from one another in this embodiment. Please refer to FIG. 4A, all the dummy pixel electrodes 330b of the dummy pixels 330 surrounding the display pixels 320 can be electrically connected to one another, thus the dummy pixel electrodes 330b may share the ESD current at the same time, to further prevent the display pixels 320 from being damaged. Besides, please refer to FIG. 4B, the dummy pixel electrodes 330b of the dummy pixels 330 arranged on the outer rows or the outer columns can be electrically connected to one another as shown in FIG. 4B. The layout of the dummy pixel electrodes 330b of the dummy pixels 330 is not restricted in the present invention.

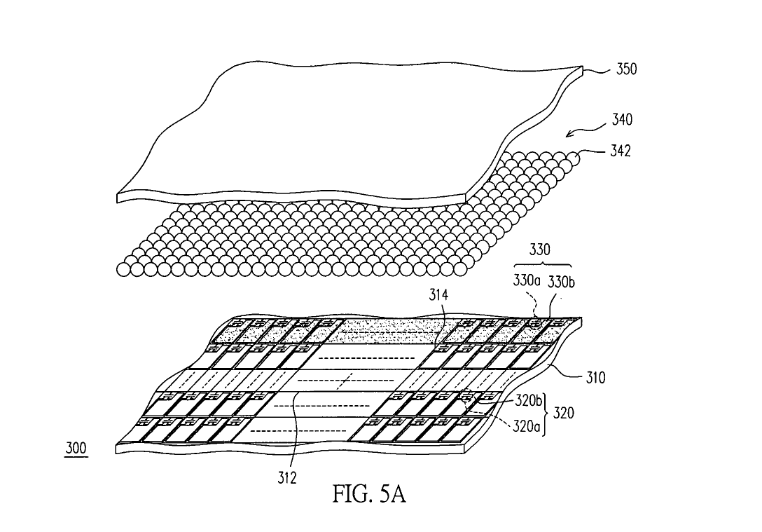

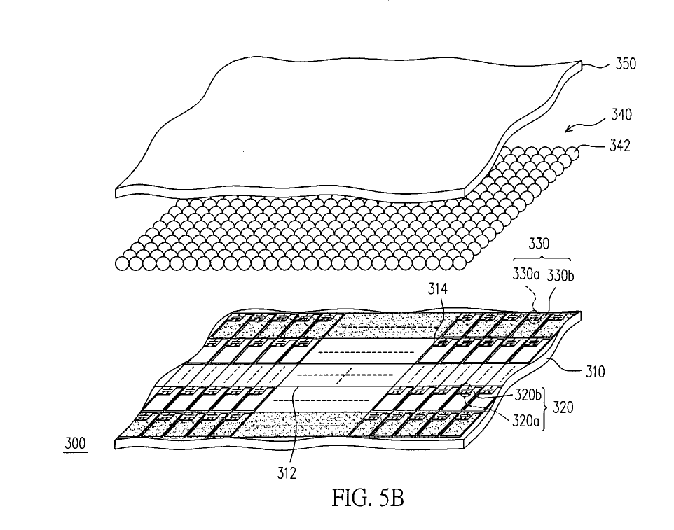

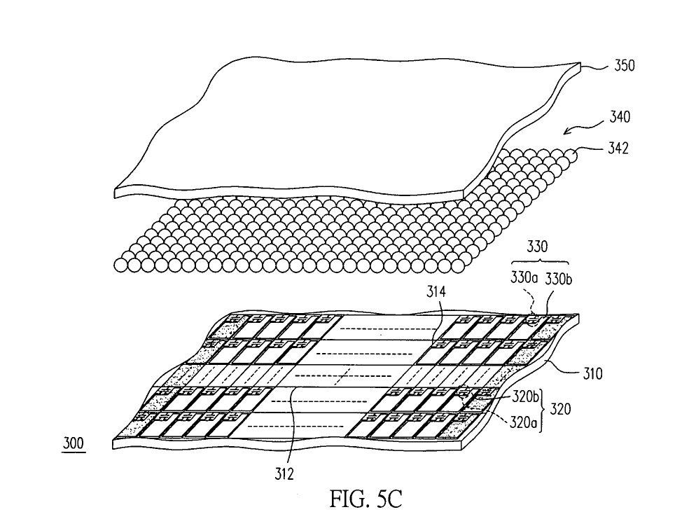

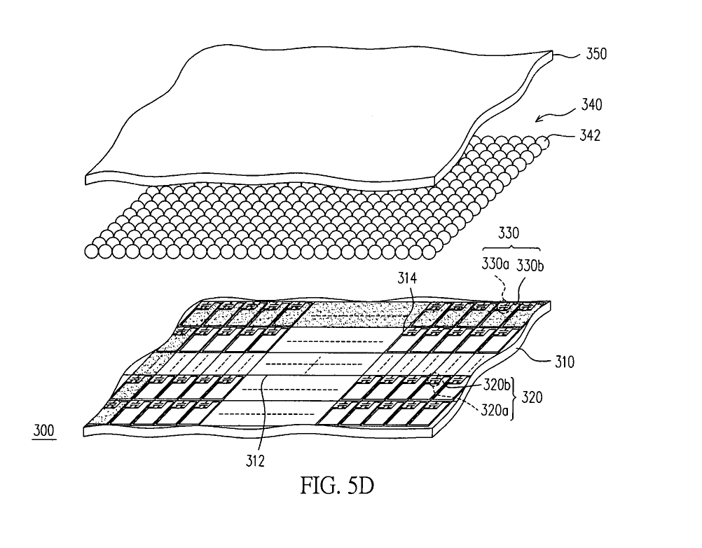

Except surrounding with the display region, the dummy pixels 330 may have different arrangement in accordance with practical demands. Please refer to FIG. 5A, the dummy pixels 330 are disposed on at least one side of the display region defined by the display pixels 320. Next, please refer to FIGS. 5B and 5C, the dummy pixels 330 are disposed on two parallel sides, like the outer rows or columns, of the display region. Finally, please refer to FIG. 5D, the dummy pixels 330 are disposed on two adjacent sides of the display region. The arrangement of the dummy pixels 330 is not limited in the present invention.

In summary, the present invention utilizes the arrangement of the dummy pixels adjacent to the display pixels, to prevent the display pixels from being damaged directly due to an ESD and further improve the display quality and the manufacturing yield of the E-ink display panel. Thus, the dummy pixels serve as an ESD protection device for the E-ink display panel. Besides, the layout of the dummy pixels can be identical with that of the display pixels to simplify the fabrication process of the E-ink display panel; otherwise, the layout of the dummy pixels can be different from that of the display pixels in accordance with practical demands. Furthermore, all the dummy pixel electrodes of the dummy pixels surrounding the display pixels can be electrically connected to one another, and thus they may share the ESD current at the same time, to further prevent the display pixels from being damaged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic ink display panel, comprising:
a substrate;
a plurality of display pixels disposed on the substrate and arranged in a matrix for defining a display region;
a plurality of dummy pixels disposed on the substrate, wherein the dummy pixels are adjacent to the display pixels;
a display medium disposed over the display pixels and the dummy pixels; and
a common electrode disposed on the display medium, wherein the display medium above the display pixels is driven by the bias voltage between the display pixel and the common electrode such that an image is displayed by the display medium, and the display medium above the dummy pixels is controlled by the bias voltage between the dummy pixel and the common electrode.

2. The electronic ink display panel according to claim 1, wherein each display pixel comprises a display thin film transistor disposed on the substrate and a display pixel electrode electrically connected thereto, and each dummy pixel comprises a dummy thin film transistor disposed on the substrate and a dummy pixel electrode electrically connected thereto.

3. The electronic ink display panel according to claim 2, wherein all the dummy pixel electrodes of the dummy pixels are electrically connected together.

4. The electronic ink display panel according to claim 2, wherein a portion of the dummy pixel electrodes of the dummy pixels are electrically connected to one another.

5. The electronic ink display panel according to claim 2, wherein the dummy pixel electrodes of the dummy pixels are electrically isolated from one another.

6. The electronic ink display panel according to claim 1, wherein the substrate comprises a rigid substrate or a flexible substrate.

7. The electronic ink display panel according to claim 1, wherein the layout of the display pixels is identical with that of the dummy pixels.

8. The electronic ink display panel according to claim 1, wherein the layout of the display pixels is different from that of the dummy pixels.

9. The electronic ink display panel according to claim 1, wherein the dummy pixels are disposed on at least one side of the display region.

10. The electronic ink display panel according to claim 1, wherein the dummy pixels are disposed on two parallel sides of the display region.

11. The electronic ink display panel according to claim 1, wherein the dummy pixels are disposed on two adjacent sides of the display region.

12. The electronic ink display panel according to claim 1, wherein the display region is surrounded by the dummy pixels.
